(19) United States
(12) Patent Application Publication
(10) Pub. No.: US 2008/0087080 A1
(43) Pub. Date: Apr. 17, 2008

(54) Vessel of a portable handheld work apparatus

(75) Inventors: Fabian Gwosdz, Schorndorf (DE); Jorg Schlossarczyk, Winnenden (DE)

Correspondence Address: WALTER OTTESEN, PO BOX 4026, GAITHERSBURG, MD, 20885-4026, US

(73) Assignee: Andreas Stihl AG & Co. KG.

(21) Appl. No.: 11/907,003

(22) Filed: Oct. 9, 2007

(30) Foreign Application Priority Data
Oct. 13, 2006 (DE) 102006048550.5

(51) Int. Cl. G01F 23/02

(52) U.S. Cl. 73/323

(57) ABSTRACT

A vessel (1) of a portable handheld work apparatus is provided for liquid operating substances such as fuel, oil or the like. The vessel (1) has a vessel wall (2) of injection-molded plastic and a viewing window (3) integrated into the vessel wall (2). The viewing window is provided for viewing the fill level. The vessel wall (2) and the viewing window (3) are configured as a two-component injection-molded part. Mutually adjoining edges (4, 5) of the vessel wall (2) and the viewing window (3) have a tongue-and-groove connection (6) with at least one groove (7) and at least one tongue (8).

### CROSS REFERENCE TO RELATED APPLICATION

This application claims priority of German patent application no. 10 2006 048 550.5, filed Oct. 13, 2006, the entire content of which is incorporated herein by reference.

### FIELD OF THE INVENTION

The invention relates to a vessel of a portable handheld work apparatus for liquid operating substances such as fuel or the like.

### BACKGROUND OF THE INVENTION

Handheld portable work apparatus such as chain saws, cutoff machines or the like have one or several vessels for liquid operating substances. These vessels hold fuel for an internal combustion engine of the work apparatus, oil for the saw chain of a chain saw or the like.

A control of the fill level of the operating liquid in the vessel is necessary from time to time. This can take place, for example, with a dipstick. Especially vessels having a vessel wall of injection-molded plastic with a viewing window integrated into the wall of the vessel are provided for viewing the fill level. An integrated viewing window of this kind is, for example, formed by configuring the vessel wall from diffusedly transparent plastic. The vessel component, which is configured to be transparent, is, overall, injection cast from partially crystalline plastic and this makes possible a visual control of the fill level.

The transparency of suitable plastic is, however, limited. The fill level of an approximately glass clear liquid such as gasoline or the like can only be detected with difficulty.

The vessel component configured in this manner satisfies esthetic requirements only in a limited manner. The requirement of transparency limits the selection of materials whereby the mechanical loading capacity is limited. A liquid tight and mechanically loadable connection or bond of the transparent vessel part to an adjacent housing part, which forms section-wise a part of the vessel, is difficult to realize.

### SUMMARY OF THE INVENTION

It is an object of the invention to improve a vessel of the kind described above so that an optical fill level detection is simplified while ensuring the liquid tightness.

The vessel of the invention is for a portable handheld work apparatus for holding a liquid operating substance such as fuel, oil or the like. The vessel includes: a vessel wall of injection-molded plastic; a viewing window integrated into the vessel wall for viewing the fill level of the operating substance; the vessel wall and the viewing window being configured as a two-component injection-molded part; the vessel wall and the viewing window having respective edges which are mutually adjoining; and, the mutually adjoining edges conjointly defining a tongue-and-groove connection including at least one groove and at least one tongue.

A vessel is suggested having a vessel wall and a viewing window configured as a two-component injection-molded part. Mutually adjoining edges of the vessel wall and the viewing window conjointly define a tongue-and-groove connection with at least one groove and at least one tongue. Preferably, the tongue-and-groove connection extends over the entire length of the mutually adjoining edges. The vessel wall can be injection molded from a structurally highly loadable, nontransparent plastic while the material selection for the likewise injection-cast viewing window can be selected exclusively in accordance with a viewpoint of good optical transmissivity. The arrangement has a high mechanical loading capacity. The structural material of the vessel wall can be easily and reliably connected to a further housing component by welding or the like. The tongue-and-groove connection between the vessel and the viewing window generates a large contact surface between the two different plastic materials of the vessel wall and the viewing window whereby a permanent liquid tight connection is ensured between the viewing window and the adjoining wall section. The injection-molded bond of the two materials, which occurs in the tongue-and-groove connection, furthermore exhibits a high carrying capacity.

If the component of the outer wall and the viewing window exhibits a common free abutting edge which is provided for a later connection to another housing part, for example, by welding, the formation of the tongue-and-groove connection is purposeful only in that edge region wherein the viewing window joins the neighboring region of the vessel wall. The tongue-and-groove connection is interrupted at the common abutting edge and therefore does not extend around the entire periphery. The liquid tightness in the region of the abutting edge is established by the later connection via adhesive or welding. In a practical embodiment, the tongue-and-groove connection runs without interruption around the entire periphery of the viewing window. In the manufacture of the two-component injection-molded part, a peripherally extending uninterrupted seal results in one work step.

The vessel wall with the integrated viewing window can be a classical two-component injection-molded part manufactured, for example, in accordance with the core-back process or the rotating plate process. The viewing window is advantageously configured as an insert part especially in the embodiment with a tongue-and-groove connection surrounding the entire periphery. The insert part is injection molded as a separate individual part and the material of the vessel wall is injected around the insert part. The insert part is produced in advance in a separate injection molding form wherein, with simple means, the formation of at least one groove and at least one tongue is possible. Thereafter, the viewing window in the form of an insert part is inserted, positioned and thereafter the structural material of the vessel wall is injected around the insert part by means of a suitable device in the injection molding form for the vessel wall. The injection molding form for the vessel part can also be configured simply and cost effectively in that sliders or the like are not required for the formation of the tongue-and-groove connection.

In a preferred further embodiment, the groove and the tongue extend in a surface pregiven by the vessel wall and the viewing window. The viewing window and the bordering region of the vessel wall exhibit essentially a constant thickness. The transverse cross sectional longitudinal axes of the groove and tongue lie parallel to the wall surface. Little space is needed especially in the direction of the wall thickness and high liquid tightness and mechanical loadability are combined with each other. Additional thickening in the connecting region is not required. A smooth surface results in the region of the connection which is free of thickness jumps. The arrangement is less sensitive with respect to contamination and can be easily cleaned.

In a preferred embodiment, the glass transition temperature of the plastic material of the viewing window is less than or equal to the glass transition temperature of the plastic material of the vessel wall. In the manufacture of the two-component injection-molded part, the viewing window is first injection molded and thereafter the structural material of the vessel wall is injected around the viewing window. The lower glass transition temperature of the viewing window leads to the situation that the plastic material thereof melts slightly in the region of the tongue-and-groove connection and enters into an intimate material bond with the freshly injected structural material. To further increase the bond, it can be practical that the tongue is provided with cutouts. These cutouts are filled out during the injection molding process of the second material component and generate an additional highly loadable form tight connection.

To further increase the liquid tightness and the carrying capacity, a ratio of the width of the tongue to the width of the viewing window of at least 0.2 and a thickness of the portion bordering the groove of at least 0.2 mm has proven to be practical.

In an advantageous further embodiment, the viewing window has a recess with a thickness reduced compared to the edge region. It can also be practical that the viewing window is, in addition or alternatively to the recess, configured at least sectionally as a diffusing glass having a light diffracting surface structure arranged especially at the inner surface. In this way, the optical characteristics of the viewing window improve still further and therefore the readability of the fill level of the vessel is further improved.

### BRIEF DESCRIPTION OF THE DRAWINGS

The invention will now be described with reference to the drawings wherein:

FIG. 1 is a perspective view of a cover for an operating substance vessel configured as a two-component injection-molded part having a viewing window integrated into the vessel wall;

FIG. 2 is a cross-sectional view of the cover of FIG. 1 with details of a peripherally extending tongue-and-groove connection of the viewing window to the vessel wall;

FIG. 3 is a front elevation view of a further embodiment of the invention having a viewing window which is integrated into a housing part by means of an only partially peripherally extending tongue-and-groove connection;

FIG. 4 is a side elevation view of the arrangement of FIG. 3 showing details of the configuration of the tongue-and-groove connection;

FIG. 5 is a longitudinal section view of the housing part of FIG. 4 showing further details with respect to the course of the tongue-and-groove connection;

FIG. 6 is a schematic diagram of a two-component injection-molded part according to the invention showing details as to the geometric configuration of the tongue and groove with constant thickness; and,

FIG. 7 is a variation of the arrangement of FIG. 6 with respective conically configured tongues and grooves.

### DESCRIPTION OF THE PREFERRED EMBODIMENTS OF THE INVENTION

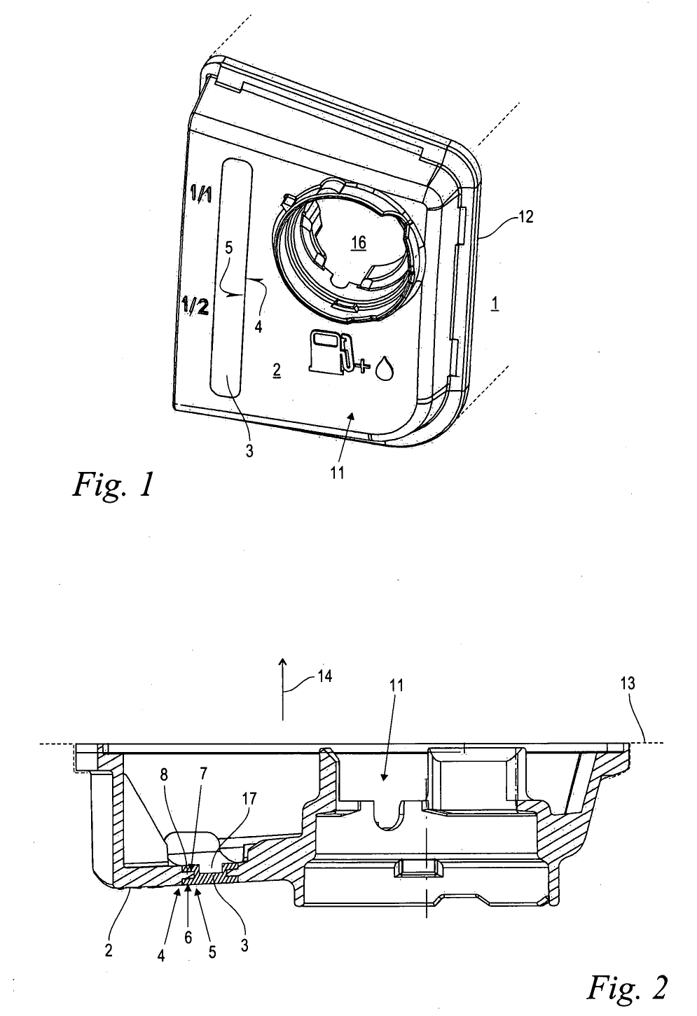

FIG. 1 shows a perspective view of a vessel 1 of a portable handheld work apparatus such as a cutoff machine or the like. The vessel 1 is for liquid operating substances such as fuel, oil or the like. Part of the vessel 1 is a cover part 11 configured as a two-component injection-molded part wherein a venting opening 16 as well as a viewing window 3 are arranged in the end face vessel wall 2. In the embodiment shown, the vessel 1 is provided for accommodating a fuel/oil mixture for supplying a loss-lubricated internal combustion engine of the work apparatus. The fuel/oil mixture is filled via the fill opening 16 into the vessel 1. The fill opening 16 is thereafter closed by a cap (not shown). The fill level of the operating substance in the vessel 1 can be detected via the transparent viewing window 3 and can be controlled in this manner.

FIG. 1 shows that the elongated viewing window 3 has a peripherally-extending edge 5 on which the edge 4 of the adjoining region of the vessel wall 2 borders. The edge 4 likewise is completely peripherally extending. The adjoining region of the vessel wall 2 accordingly completely peripherally encloses the viewing window 3 and conjointly defines therewith the vessel wall 2. The viewing window 3 is made of transparent, injection-molded plastic. Preferably, an amorphous plastic is selected which is at least approximately glass clear. A partially crystalline, diffusedly transparent plastic can be practical. The remaining sections of the cover part 11 are from a highly-stressable, shock-resistant, non-transparent plastic which is especially filled and colored.

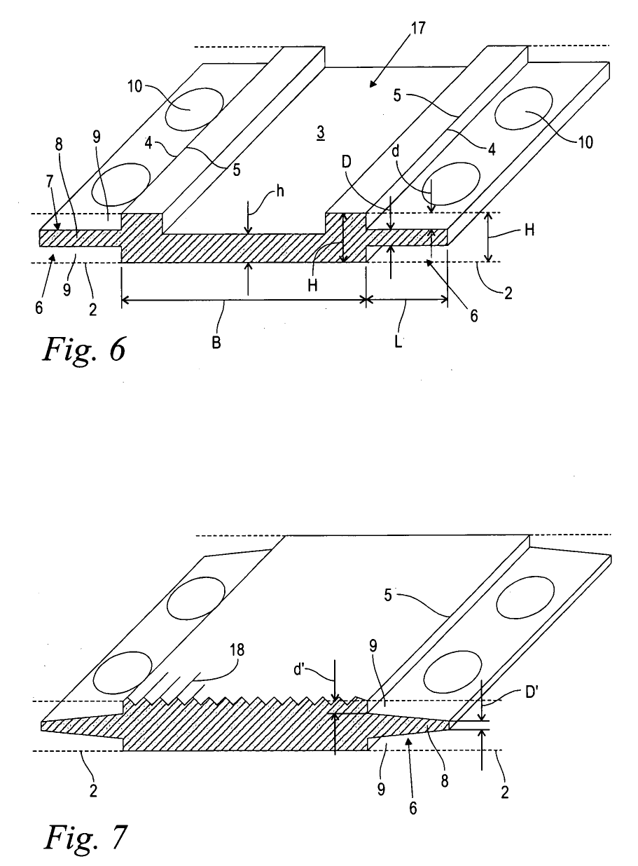

FIG. 2 shows a transverse cross section of the cover part 11 of FIG. 1 which is manufactured in an injection molding form indicated schematically by reference numeral 13. Optionally, the viewing window 3 can have a recess 17 and the details thereof are explained later in connection with FIG. 6. The cross-sectional view of FIG. 2 shows that the mutually adjoining edges (4, 5) of the vessel wall 2 and of the viewing window 3 conjointly define a groove-and-tongue connection 6. The tongue-and-groove connection 6 extends over the entire length of the mutually adjoining edges (4, 5) and therefore surrounds the viewing window 3 uninterruptedly in accordance with FIG. 1.

For the groove-and-tongue connection 6, the viewing window 3 is provided with a peripherally extending groove 7 into which a likewise peripherally extending tongue 8 of the adjoining region of the vessel wall 2 engages. A reverse arrangement can also be practical wherein the groove 7 is assigned to the vessel wall 2 and the tongue 8 is assigned to the viewing window 3.

A form half of the injection molding form 13 is indicated in FIG. 2. The completed cover part 11 is taken out of this form half in a direction of extraction indicated by arrow 14. The region of the vessel wall 2 with the integrated viewing window 3 forms a surface which lies essentially transversely to the extraction direction 14. For making the cover 11 with the tongue-and-groove connection 6 in the multi-component injection molding process, the production can be practical with a turning tool or in accordance with a core-back process. In the embodiment shown, the viewing window 3 is configured as an insert part and is manufactured as a separate individual part by injection molding in an independent injection molding form (not shown).

For forming the cover part 11, the viewing window 3 in the form of an insert part is first placed in the injection molding form 13 utilizing a suitable grabber and is positioned at the wanted location. Thereafter, the structural material of the vessel wall 2 is injected around the viewing window 3. The melt of the structural material penetrates into the peripherally extending groove 7 of the viewing window 3 and thereby forms a likewise peripherally extending tongue 8. To produce an intimate material bond, the glass transition temperature of the plastic material of the viewing window 3 is less than or equal to the glass transition temperature of the plastic material of the vessel wall 2. The melt of the subsequently injected structural material, as a consequence of its processing temperature, leads to a surface melting of the plastic material of the viewing window 3 in the region of its peripherally extending edge 5. Preferably, like plastic materials are selected for the viewing window 3 and for the surrounding structural material which differ only in translucency or coloring and filling. Because of the partial melting in connection with the tongue-and-groove joint 6, a two-component injection-molded part results with a permanently reliable liquid tightness and loading capability in the region of the edges (4, 5) while having a thin wall thickness.

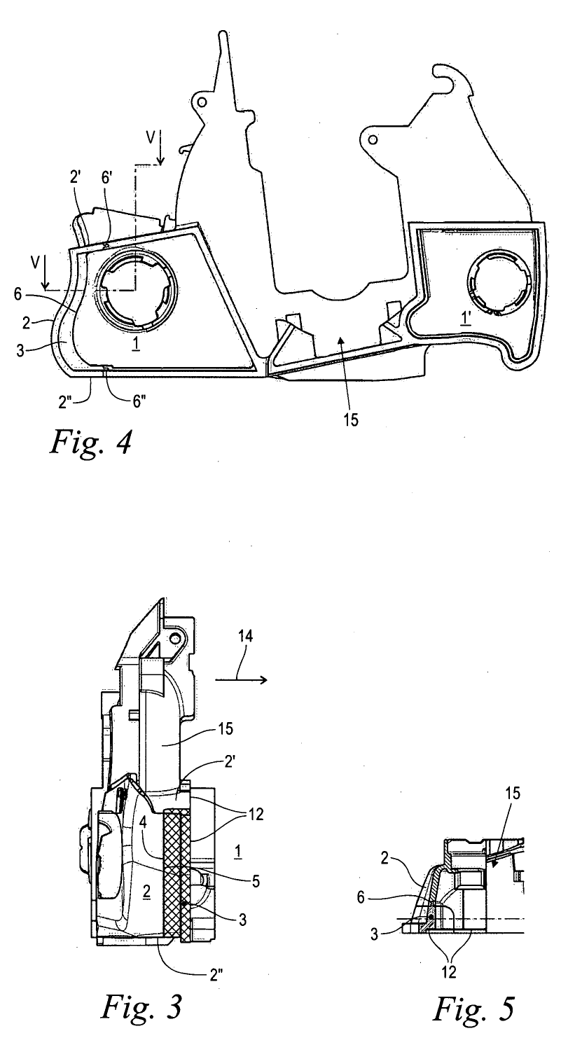

FIG. 3 shows a further embodiment of the invention in the example of a housing part 15 of which the end face is shown. The housing part 15 is, for example, a housing part of a motor-driven chain saw. The housing part 15 includes an integrated section which, together with a further housing part (not shown), forms the vessel 1. For this purpose, vessel walls (2, 2′, 2″) are formed as one piece on the housing part 15 wherein the viewing window 3 is integrated. The housing part 15 is configured as a half shell whose extraction direction 14 out of an injection molding form 13 (FIG. 2) lies transversely to the opening plane of the half shell. In the embodiment shown, the surfaces of the vessel walls (2, 2′, 2″) lie approximately parallel to the extraction direction 14. The mutually adjoining edges (4, 5) of the vessel wall 2 and the viewing window 3 do not completely surround the viewing window 3; instead, they end at a common abutting edge 12 of the housing part 15.

FIG. 4 shows a side elevation view of the housing part 15 viewed from its open end. The housing part 15 is configured as a half shell. In this view, the vessel 1 is enclosed on all sides by the vessel walls. The viewing window 3 extends over the end vessel wall 2, the upper vessel 2′ and the lower vessel wall 2″. In the region of the vessel walls (2, 2′, 2″), a tongue-and-groove connection (6, 6′, 6″) is provided between the viewing window 3 and the adjoining regions of the vessel walls (2, 2′, 2″). The tongue-and-groove connections (6′, 6″) are shown schematically in FIG. 4. FIG. 5 shows a longitudinal section view of the arrangement of FIG. 4 along the section line V-V. The configuration of the tongue-and-groove connection 6 can also be seen in the vessel wall 2.

Referring to FIGS. 3 to 5, it can be seen that the tongue-and-groove connections (6, 6′, 6″) pass over one into the other and extend over the entire lengths of the mutually adjoining edges (4, 5) and end at the common peripherally-extending abutting edge 12 of the housing part 15 with the viewing window 3.

As in the embodiment of the FIGS. 1 and 2, the viewing window 3 can be configured as an insert part. Its flat arrangement parallel to the extraction direction 14 (FIG. 3) permits, however, also the manufacture of the housing part 15 together with the integrated viewing window 3 as a two-component injection-molded part with a turning tool and in accordance with the core-back process while forming the tongue-and-groove connections (6, 6′, 6″). In this context, it is especially possible to first inject the structural material of the housing part 15 into the injection molding form 13 (FIG. 2) and only then to inject the transparent plastic for the viewing window 3. In this case, the above-described relationship of the two glass transition temperatures reverses with respect to each other.

After the removal from the injection molding form 13 (FIG. 2), the above-described housing part 15, which is configured as a two-component injection-molding part, is joined liquid tight to a further shell-shaped housing part, for example, by welding or by cementing along the peripherally-extending abutting edge 12 whereby the closed vessel 1 is produced. In FIG. 4 it can be seen that in housing part 15 there is a further vessel 1′. This further vessel 1′ is, for example, for oil or the like and can be configured in correspondence to the vessel 1 of FIG. 4 or in correspondence to the embodiment of FIGS. 1 and 2. The remaining features and reference numerals correspond to those of the vessel 1 according to FIGS. 1 and 2.

FIG. 6 shows a perspective cutaway view of the arrangement of the invention wherein the vessel wall 2 with the integrated viewing window 3 is configured as a flat component. The edge region of the viewing window 3 and the adjoining region of the vessel wall 2 have an essentially constant and same thickness H. It can be practical that the viewing window 3 has a constant thickness H over its entire surface. In the embodiment shown, the viewing window 3 is provided, in its center region, with a recess 17 within which the viewing window has a thickness (h) which is less in comparison to the thickness H of the edge region. The inner and the outer surfaces of the viewing window 3 are polished at least in the region of the recess 17, which, in combination with the reduced thickness (h), contributes to improved optical characteristics. The polished surfaces result from a forming from the polished surfaces of the injection molding form 13 (FIG. 2). Additionally or alternatively to the recess 17, a light-scattering surface structuring 18 according to FIG. 7 can be advantageous to improve the optical characteristics. The longitudinal axes of the cross-sectional forms of groove 7 and tongue 8 run parallel to the surface pregiven by the vessel wall 2 having the integrated viewing window 3.

In the direction of the cross-sectional longitudinal axes, the tongue 8 has a width L and the viewing window 3 has a width B. The ratio of the width L to the width B is at least 0.2. The peripherally-extending tongue 8 has a thickness D in the thickness direction of the viewing window 3. This thickness D corresponds to the height of the groove 7. In the thickness direction, the groove 7 is delimited by two opposite-lying struts 9 having respective thicknesses (d). The thickness D of the tongue 8 and the thickness (d) of the strut 9 are in each case at least 0.2 mm. The cross-sectional form of the groove 7 and the tongue 8 is at least approximately rectangular from which a constant thickness D and a constant thickness (d) results.

The view of FIG. 6 shows that the tongue 8 is provided with a plurality of cutouts 10. The cutouts 10 are each provided with a circularly-shaped contour by way of example. Elongated holes as well as cutouts 10 open to the edge can also be practical. During the injection molding process, the structural material of the vessel wall 2 penetrates into the cutouts 10 and generates also a form-tight connection in addition to the material bond.

Departing from the embodiment of FIGS. 1 and 2, the tongue 8 is part of the viewing window 3 whereas the groove 7 is formed in the adjoining material of the vessel wall 2. This facilitates the manufacture of the viewing window 3 as insert part with reduced form complexity. However, the reverse embodiment having a groove 7 at the edge 5 of the viewing window 3 can be practical.

FIG. 7 shows a variation of the arrangement of FIG. 6 wherein the thicknesses of the cross-sectional form of the groove 7 and of the tongue 8 decrease outwardly starting from the edge 5. The struts 9 and the tongue 8 have minimum thicknesses of (d′) and D′, respectively, which are preferably at least 0.2 mm.

To improve the optical characteristics of the viewing window 3 in the sense of an improved readability of the fill level of the vessel, the viewing window 3 can be provided with a recess 17 according to FIG. 6. In the embodiment shown and for this purpose, a light-diffracting surface structuring 18 is provided on the surface of the viewing window 3 facing toward the interior of the vessel whereby the viewing window 3 is configured as diffusing glass. The surface structuring extends over the entire surface of the viewing window 3 but can also be limited to individual sections. The surface structuring 18 can also be advantageous in combination with the recess 17 of FIG. 6. The surface structuring extends, for example, only over the region of the recess 17. On the other hand, it can be practical to provide only the region outside of the recess 17 with the surface structuring 18; whereas, the recess 17 itself is configured to be smooth. The outer side of the viewing window 3 faces away from the vessel interior and is, as in the embodiment of FIG. 6, configured to be smooth. With respect to the remaining features and reference numerals, the arrangement of FIGS. 6 and 7 corresponds to the embodiment shown in FIGS. 1 and 2 as well as the embodiments shown in FIGS. 3 to 5.

In the embodiments shown, only one peripherally extending tongue 8 engages into an assigned groove 7. It can, however, be practical to arrange several grooves 7 and tongues 8 in the thickness direction one above the other.

It is understood that the foregoing description is that of the preferred embodiments of the invention and that various changes and modifications may be made thereto without departing from the spirit and scope of the invention as defined in the appended claims.

What is claimed is:

1. A vessel of a portable handheld work apparatus for holding a liquid operating substance such as fuel, oil or the like, the vessel comprising:
a vessel wall of injection-molded plastic;
a viewing window integrated into said vessel wall for viewing the fill level of said operating substance;
said vessel wall and said viewing window being configured as a two-component injection-molded part;
said vessel wall and said viewing window having respective edges which are mutually adjoining; and,
said mutually adjoining edges conjointly defining a tongue-and-groove connection including at least one groove and at least one tongue.

2. The vessel of claim 1, wherein said tongue-and-groove connection extends over the entire lengths of said mutually adjoining edges.

3. The vessel of claim 1, wherein said tongue-and-groove connection extends uninterruptedly around said viewing window.

4. The vessel of claim 1, wherein said viewing window is an insert part injection molded separately from said vessel wall; and, said plastic of said vessel wall is injection molded around the periphery of said insert part.

5. The vessel of claim 1, wherein the tongue and the groove of said tongue-and-groove connection extend in a region pregiven by said vessel wall and said viewing window.

6. The vessel of claim 1, wherein said viewing window has a border region extending from said tongue-and-groove connection and said vessel wall has a border region extending from said tongue-and-groove connection; and, said border regions each have an essentially constant thickness (H).

7. The vessel of claim 1, wherein said viewing window has a first glass transition temperature and said vessel wall has a second glass transition temperature; and, said first glass transition temperature is equal to or less than said second glass transition temperature.

8. The vessel of claim 1, wherein the ratio of a width (L) of the tongue of said tongue-and-groove connection to a width (B) of said viewing window is at least 0.2.

9. The vessel of claim 8, wherein two flanges conjointly define the groove of said tongue-and-groove connection; and, said flanges each have a thickness (d) of at least 0.2 mm.

10. The vessel of claim 1, wherein the tongue of said tongue-and-groove connection includes a plurality of cutouts.

11. The vessel of claim 1, wherein said viewing window has a border region extending from said tongue-and-groove connection; and, said viewing window has a recess formed therein and said recess has a thickness (h) which is reduced relative to said border region.

12. The vessel of claim 1, wherein said viewing window is configured at least sectionally of diffusing transparent material having a light-diffracting surface structure.

13. The vessel of claim 12, wherein said light-diffracting surface structure is arranged on the inner surface of said viewing window.
